(19) United States
(12) Patent Application Publication
(10) Pub. No.: US 2026/0144692 A1
(43) Pub. Date: May 28, 2026

(54) POSITIONING SYSTEM FOR PRONE POSITION

(71) Applicant: BONE FOAM, INC., Corcoran, MN (US)

(72) Inventors: Arman Dagal, Bainbridge Island, WA (US); Benjamin J. Watters, III, Saint Louis Park, MN (US); Clinton J. McCullough, Blaine, MN (US); Peter A. Cole, JR., North Oaks, MN (US)

(21) Appl. No.: 19/122,194

(22) PCT Filed: Oct. 17, 2023
(86) PCT No.: PCT/US2023/077087

§ 371 Date: Apr. 17, 2025

Related U.S. Application Data
(60) Provisional application No. 63/416,847, filed on Oct. 17, 2022.

(51) Int. Cl. A61G 13/12

(52) U.S. Cl. CPC A61G 13/126; A61G 13/122; A61G 13/123; A61G 2200/12; A61G 2200/325

(57) ABSTRACT

Disclosed are patient positioning systems that support a patient in the prone position, such as during surgery or recovery. A patient positioning system includes a base including an inferior section and a superior section for improved system maneuverability and configurability. A cavity extends along the inferior and superior sections, such that the chest, abdomen, and groin are relieved of pressure when a patient is placed in the prone position thereon. Channels may be placed on the bottom surface of the base to provide access to the patient's ventral surface.

### BACKGROUND

Positioning patients is critical for supporting body mechanics, soft-tissue risk mitigation, operating conditions, and operative-site access. In the prone position, the patient lies flat on the stomach. Many procedures and treatments are carried out while the patient is in the prone position, such as lumbar laminectomy, microlumbar discectomy, posterior lumbar fusion, posterior lumbar interbody fusion, transforaminal lumbar interbody fusion, rectal or buttock surgeries, and other surgeries involving the back of the arms and legs.

The prone position also beneficially increases access of air to all areas of the patient's lungs by helping a patient's lungs to expand fully. Therefore, the prone position is often used to increase ventilation for patients suffering acute respiratory distress syndrome (ARDS), which may be caused by conditions such as COVID-19, pneumonia, pancreatitis, sepsis, or injuries resulting from breathing harmful substances or from wounds to the head or chest.

However, prone positioning presents challenges for patient's safety and surgical efficiency. Traditionally, patients were placed face-down on an operating table when undergoing spinal or back surgery, but patients were found susceptible to increased blood loss during surgery when pressure, supplied by a patient's weight, was applied to the abdomen. Various devices have been developed to help relieve this pressure on the patient's ventral surface. However, previous devices are generally large and cumbersome, making them difficult to maneuver, as well as flat and rigid, poorly distributing a patient's weight which results in sore spots and impaired blood flow.

Other devices suffer from a lack of available options in positioning the patient, especially for transitioning the patient from a straight position to a position where they bend at the waist. Also, many devices provide difficult or no access to the anterior surface of the patient. Therefore, a need exists for a patient positioning system that is easily maneuverable and adjustable, while providing improved support and access to the patient's ventral surface.

### SUMMARY

Disclosed are patient positioning systems that support a patient in the prone position. A patient positioning system includes an inferior section and a superior section, which when joined together form a base, and a cavity extending along both the inferior and superior sections. The inferior and superior sections support the upper chest, pelvis, and sides of the patient, relieving pressure on the patient's lower chest, abdomen, and groin. Channels can be located on the bottom surface of the positioning system, providing access to the cavity and thus to the patient's ventral surface.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 is a top perspective view of an exemplary embodiment of a positioning system.

FIG. 2 illustrates a top view of an exemplary embodiment of a positioning system.

FIG. 3 is a top perspective view of an exemplary embodiment of a positioning system with the inferior section and superior section separated.

FIG. 4 is a bottom perspective view of an exemplary embodiment of a positioning system.

FIG. 5 illustrates a side view of an exemplary embodiment of a positioning system.

FIG. 6 illustrates a front view of an exemplary embodiment of a positioning system.

FIG. 7 illustrates a rear view of an exemplary embodiment of a positioning system.

### DETAILED DESCRIPTION

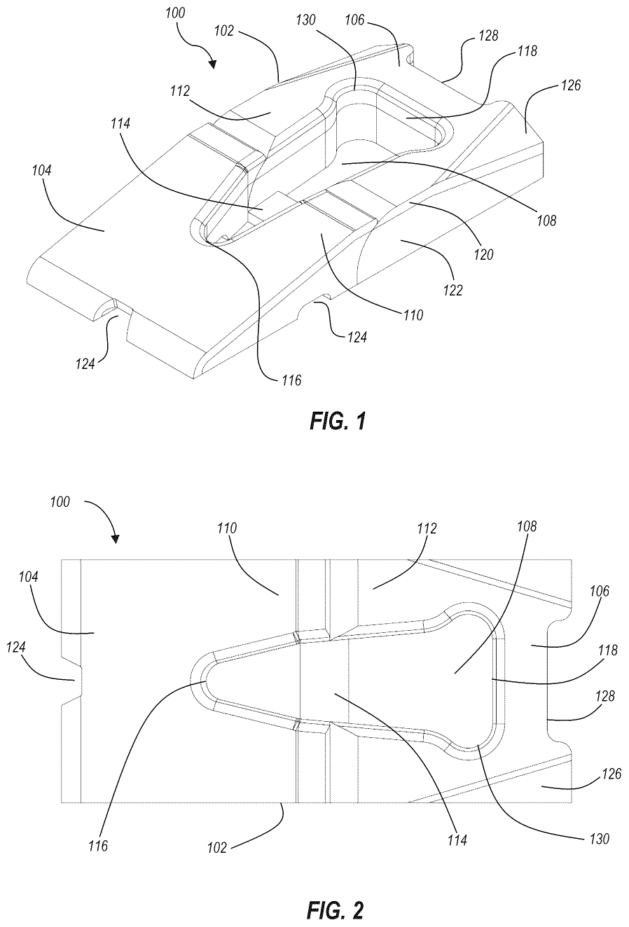

FIG. 1 illustrates an exemple prone positioning system 100. The positioning system 100 includes a base 102 for supporting the chest and pelvis of a patient while in a prone position. The base 102 comprises a superior section 106 and an inferior section 104 that together define a cavity 108. The cavity 108 extends longitudinally, i.e., along an inferior to superior direction, along both a portion of the superior section 106 and a portion of the inferior section 104. Lateral sides 110 and 112 are positioned to either side of the cavity 108

The cavity 108 is bounded by lateral sides 110 and 112 of the inferior section 104 and superior section 106 as well as an inferior end (formed by the inferior end of the inferior section 104) and a superior end (formed by the superior end of the superior section 106). The lateral sides 110 and 112 of the inferior section 104 and superior section 106 support the sides of a patient's chest, the patient's abdomen, and the patient's groin. The inferior end of the inferior section 104 supports the patient's thighs, and the superior end of the superior section 106 supports the patient's upper chest and shoulders. Thus, the lateral sides 110 and 112, the inferior end of the inferior section 104, and the superior end of the superior section 106 distribute the patient's weight so as to relieve pressure on the patient's lower chest, abdomen, and groin when the patient is placed in a prone position atop the positioning system 100.

The base 102 may be formed from materials sufficient to support the patient's body, such as foam (including memory foam, polyurethane foam, closed cells foam, and latex foam), rubber, gel, other supportive materials, or combinations thereof. Additionally, the base 102 may be formed from a uniform material or alternatively may include multiple horizontal layers (i.e., multiple layers that stack from bottom to top). The base 102 may include two layers, three layers, or more than three layers. FIG. 1 illustrates an embodiment wherein the base 102 is formed from a top layer 120 and a bottom layer 122. The bottom layer 122 of the base 102 may be formed from a material that provides greater structural support and the top layer 120 of the base 102 may be formed from a softer material, such as memory foam, or other material that is configured to cushion the joints of the patient and to prevent pressure sores while the patient is positioned atop the positioning system 100.

The cavity 108 may extend from the top surface of the base 102 to the bottom surface of the base 102. That is, the cavity 108 may be open on both the upper and lower surfaces of the base 102, as shown by the illustrated embodiment. However, in other embodiments the cavity 108 may extend from the top surface of the base 102 only partially toward the bottom surface of the base 102, such as only halfway to the bottom surface of the base 102 or less than halfway to the bottom surface of the base 102. The longitudinal length of the cavity 108 may be configured to accommodate an average adult patient, such as a patient of average height and weight. For example, a person of average height can be between approximately 170 centimeters and 180 centimeters tall for men, or between 156 centimeters and 167 centimeters tall for women. In other embodiments, the longitudinal length of the cavity 108 may be longer or shorter to accommodate taller-than-average or shorter-than-average patients, respectively.

The cavity 108 may take different configurations to better accommodate various shapes corresponding to different patient's body types. FIG. 2 presents the top view of the example positioning system 100, showing that the cavity 108 narrows towards the inferior end 116 of the cavity 108 such that the inferior section 104 will maximally support the patient's pelvis while avoiding the direct placement of pressure on the patient's groin. This beneficially increases the surface area of the positioning system 100 used to support the patient's lower body, distributing the weight of the patient's lower body over a greater area and minimizing the potential impairment of blood flow and the formation of pressure sores.

Conversely, the cavity 108 may widen towards the superior end 118 of the cavity 108, enabling the cavity 108 to better accommodate a patient's chest and particularly to accommodate breasts. The cavity 108 may comprise one or more arcs 130 located at or near the superior end 118 of the cavity 108, configured to support the patient's chest while accommodating the central portion of the chest and/or breasts. The arc 130 may outline a circle whose central angle is equal to or greater than ninety degrees. This beneficially increases the surface area of the positioning system 100 used to support the patient's upper body, distributing the weight around the periphery of the patient's chest while minimizing pressure on the patient's central chest and/or breasts. Minimizing the pressure on the patient's chest in this way beneficially aids in avoiding impairment of blood flow and the formation of pressure sores. As shown, the widest portion of the cavity 108 (in a lateral direction) may be located between the arcs 130.

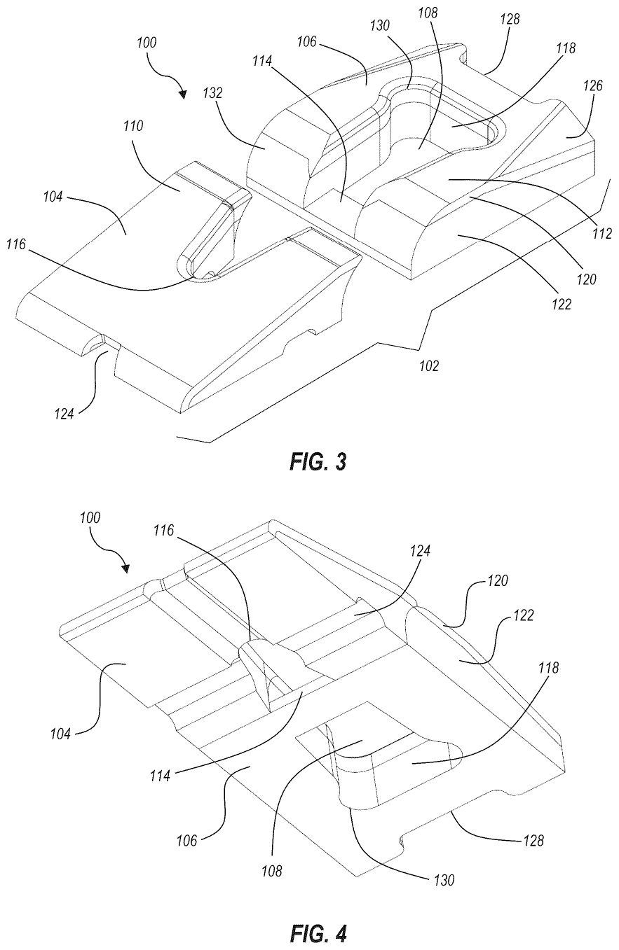

In the illustrated embodiment, the inferior section 104 and the superior section 106 are separate and distinct pieces that can be selectively adjoined or separated. FIG. 3 illustrates the positioning system 100 in a configuration in which the inferior section 104 and superior section 106 are separated a short distance. Distinct and separate sections increase the ease of maneuverability of the positioning system 100 because each section may be moved separately rather than the full base 102 all at once.

In some embodiments, an end surface 132 of the inferior section 104 and an end surface 132 of the superior section 106 are configured to correspond to one another, increasing the ease with which the inferior section 104 and the superior section 106 are placed and oriented together. In such embodiments, the inferior section 104 and the superior section 106 may be formed by cutting the base 102 along a plane dividing the end surface 132 of the inferior section 104 and the end surface 132 of the superior section 106. Alternatively, the inferior section 104 and the superior section 106 may be formed by cutting the base 102 along multiple planes.

Distinct and separate inferior and superior sections 104 and 106 also beneficially enables the sections of the base 102 to be configured in various orientations. In preferred embodiments, the end surface 132 of the inferior section 104 and the end surface 132 of the superior section 106 are shaped to enable contact along a curved plane, such that the inferior section 104 and superior section 106 may be oriented at an angle while maintaining contact along the curved plane. This beneficially allows the positioning system 100 to bend around a “hinge” and to support a patient position in which the patient is bent at the waist, increasing the available prone configurations the patient may take and thus, for example, increasing accessibility to locations on the patient's dorsal surface for particular treatments or operations. Additionally, distinct and separate inferior section 104 and superior section 106 enable the base 102 to accommodate patients of greater height by separating the inferior and superior sections 104 and 106 a short distance and/or enable the selective positioning of other components between the separate sections, if desired.

In the illustrated embodiment, the base 102 is divided between the inferior section 104 and the superior section 106 along a substantially lateral line that passes through the cavity 108, thereby dividing the cavity 108 between the inferior section 104 and the superior section 106. In some embodiments, the inferior section 104 and the superior section 106 have substantially the same longitudinal length and/or substantially the same width. In other embodiments, the inferior section 104 and the superior section 106 can have different lengths and/or different widths.

In the illustrated embodiment, the majority of the longitudinal length of the cavity 108 is disposed in the superior section 106. For example, about 55% to about 75% of the length of the cavity 108 may reside in the superior section 106. This configuration beneficially positions the cavity 108 and the dividing “hinge” at appropriate anatomical locations to enable positioning of the patient with a bent waist while maintaining appropriate orientation of the other features of the device, such as the groin and chest areas of the cavity 108.

FIG. 3 illustrates that the end surface 132 of the inferior section 104 may be cupped while the end surface 132 of the superior section 106 may include a rounded surface that corresponds to the cupped surface of the inferior section 104. However, in other embodiments the end surface 132 of the superior section 106 may be cupped while the end surface 132 of the inferior section 104 includes a rounded surface corresponding to the cupped surface of the superior section 106. In other embodiments, other corresponding surface shapes may be utilized, though curved surfaces that maintain contact over a span of relative angular positions of the inferior section 104 and superior section 106 are preferred.

The base 102 may include one or more horizontal members 114 that laterally span the cavity 108. The horizontal member 114 may be connected to the lateral sides 112 of the superior section 106, preventing the lateral sides 112 of the superior section 106 from splaying and maintaining support on the sides of the patient's body. In other embodiments, one or more horizontal members 114 may additionally or alternatively be connected to the lateral sides 110 of the inferior section 104. In preferred embodiments, the bottom surface of the horizontal member 114 is even with the bottom surface of the base 102.

The base 102 may include one or more channels 124 extending upward from the bottom surface of the base 102, oriented in such a way as to connect the cavity 108 to other portions of the base 102. The channels 124 beneficially provide access for medical instruments, such as catheters and X-ray components, to a patient in the prone position. The channels 124 may be located on the bottom surface of the inferior section 104 or the bottom surface of the superior section 106 or both. The one or more channels 124 may be independently oriented longitudinally, laterally (that is perpendicular to the longitudinal direction), and/or at an angle transverse to the longitudinal or lateral direction. FIG. 4 illustrates an embodiment of the positioning system 100 wherein channels 124, located on the bottom surface of the inferior section 104, are oriented both longitudinally and laterally and intersect at or near the inferior end of the cavity 108, providing access to a patient's groin. For example, the one or more channels 124 can beneficially provide space to enable proper orientation of a urinary catheter (and/or other medical lines) and can prevent impingement of the catheter (and/or other medical lines) between the base 102 and the underlying surface upon which the base 102 is placed.

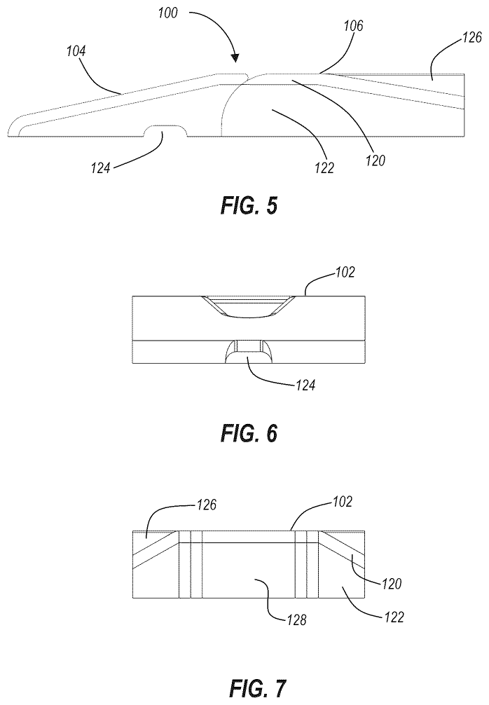

FIGS. 5-7 illustrate additional views of the exemplary positioning system 100. In this embodiment, the corner surfaces 126 at the superior end of the superior section 106 are slanted downward from the top surface of the base 102 to decrease pressure on a patient's shoulders and arms. The corner surfaces 126 may be flat, concave, convex, or a combination thereof.

The positioning system 100 may include a notch 128 located at the superior end of the superior section 106. The notch 128 may be formed to directly support or position the patient's head or to accommodate a head support device for supporting or positioning the patient's head. For example, the notch 128 can beneficially provide clearance that allows a head support device to be properly positioned relative to the other anatomical features of the base 102.

One or more securement devices may be placed on the bottom surface of the base 102 to fix the base 102 to a substructure, such as a medical operating table, an exam table, a hospital bed, stretcher, or floor. The securement device may comprise an adhesive, a hydrogel, rubber or other frictional material, a hook and loop fastener, a rope or cord, or combinations thereof. Additionally, or alternatively, one or more of such securement devices may be utilized to selectively attach the inferior section 104 and superior section 106. For example, one or more securement devices may be placed on surfaces 132.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “channel”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

The positioning system disclosed herein should be understood as comprising/including disclosed components, and may therefore include additional components not specifically described. Optionally, the positioning system disclosed herein is essentially free or completely free of components that are not specifically described. That is, non-disclosed components may optionally be omitted or essentially omitted from the disclosed positioning system.

1. A patient positioning system configured to position the patient in a prone position, the system comprising:
a base shaped to support the patient's thorax and pelvis comprising a superior section and a separate inferior section,
wherein the superior section and the inferior section form a cavity when in an assembled configuration,
wherein the cavity extends along a portion of both the superior and inferior sections,
wherein the cavity is configured to relieve pressure on the chest, abdomen, and groin of the patient.

2. (canceled)

3. The positioning system of claim 1, wherein the widest point of the cavity is at a superior end of the cavity, optionally so that the superior end of the cavity is configured to accommodate a woman's breasts.

4. (canceled)

5. The positioning system of claim 3, wherein corners of the superior section of the cavity have arcs that are curved to at least 90 degrees.

6. (canceled)

7. The positioning system of claim 1, wherein the cavity penetrates the base completely from a top surface of the base to a bottom surface of the base.

8. The positioning system of claim 1, wherein, when in a disassembled configuration, the superior section includes an open inferior end in communication with the cavity, and the inferior section includes an open superior end in communication with the cavity.

9. The positioning system of claim 1, wherein the superior section further comprises a horizontal member, wherein the horizontal member laterally spans the cavity so as to prevent lateral sides of the superior section from splaying, optionally wherein the horizontal member is attached to the lateral sides of the superior section at or near the open inferior end of the superior section.

10. (canceled)

11. The positioning system of claim 9, wherein the horizontal member is attached to the lateral sides of the superior section at or near the open inferior end of the superior section.

12. The positioning system of claim 1, wherein the inferior section inclines upwardly in an inferior to superior direction.

13. The positioning system of claim 1, wherein
the superior end of the inferior section includes a cupped surface,
the inferior end of the superior section includes a rounded surface that corresponds to the cupped surface of the inferior section,
such that the superior section may be positioned at an angle relative to the inferior section, optionally while maintaining contact between the cupped surface of the inferior section and the rounded surface of the superior section.

14. The positioning system of claim 1, wherein the base further comprises one or more channels that extend upwardly from a bottom surface of the base.

15. The positioning system of claim 14, wherein the one or more channels comprises a lateral channel and a longitudinal channel, wherein the lateral channel and the longitudinal channel intersect, optionally at or near an inferior end of the cavity.

16. (canceled)

17. (canceled)

18. (canceled)

19. (canceled)

20. The positioning system of claim 1, wherein corner surfaces at a superior end of the superior section slant downwardly relative to an upper surface of the superior section, wherein the corner surfaces at the superior end of the superior section are configured to relieve pressure on the patient's arms and shoulders.

21. (canceled)

22. The positioning system of claim 1, further comprising a notch located at the superior end of the superior section, the notch being configured to accommodate the patient's head and/or a head support device.

23. (canceled)

24. The positioning system of claim 1, wherein the base is comprised of foam.

25. The positioning system of claim 1, wherein the base comprises two or more layers.

26. The positioning system of claim 25, wherein a top layer of the base is softer than a bottom layer so that the bottom layer provides greater structural support than the top layer.

27. The positioning system of claim 26, wherein the top layer is formed from memory foam.

28. (canceled)

29. The positioning system of claim 1, wherein one or more securement devices are located on the bottom surface of the base, and wherein the one or more securement devices are configured to secure the base against a substructure.

30. The positioning system of claim 29, wherein the securement device comprises an adhesive, rubber, a hydrogel, other frictional material, hook and loop fastener, or combinations thereof.

31. A patient positioning system configured to position the patient in a prone position, the system comprising:
a base shaped to support the patient's thorax and pelvis comprising a superior section and a separate inferior section,
wherein the superior section and the inferior section form a cavity when in an assembled configuration,
wherein the cavity extends continuously along a portion of both the superior and inferior sections,
wherein the cavity is widest at a superior portion at or near the superior end of the cavity,
wherein the cavity is configured to relieve pressure on the chest, abdomen, and groin of the patient.
